(19) United States
(12) Patent Application Publication
(10) Pub. No.: US 2002/0190870 A1
(43) Pub. Date: Dec. 19, 2002

(54) Cushioned sound and flash generator

(76) Inventor: Ching-Tien Tsai, Erh-Lin City (TW)

Correspondence Address: LAW OFFICE OF LIAUH & ASSOC., 4224 WAIALAE AVE, STE 5-388, HONOLULU, HI, 96816

(21) Appl. No.: 09/882,715

(22) Filed: Jun. 14, 2001

(51) Int. Cl. G08B 7/00

(52) U.S. Cl. 340/815.7

(57) ABSTRACT

A cushioned sound and flash generator is designed for mounting in a heel of child's shoe. The sound and flash generator has a case having a sound and flash generating unit fixedly mounted therein and a cover vertically movably closed onto the case. Elastic members are positioned in the case above the sound and flash generating unit to normally support the cover at a highest possible position relative to the case. When a child walks or runs and therefore applies a downward pressure on the cushioned sound and flash generators mounted in the shoes, the elastic members are elastically compressed for the covers to elastically descend relative to the cases, preventing the child's heels and ankles from injury.

### BACKGROUND OF THE INVENTION

The present invention relates to a cushioned sound and flash generator for mounting, for example, in a heel of a child's shoe. The sound and flash generator has elastic members positioned between a cover and a watertight sound and flash generating unit, so that the cover is elastically downward movable under a pressure. Shoes having the cushioned sound and flash generators mounted therein are therefore more comfortable and safer for wearing.

Many children's shoes available in the markets are provided with flash generators that make the shoes more interesting. What is more important is these flash generators flash in the night as a warning to cars coming from a rear side and are therefore helpful in protecting children walking in the night.

Such flash generator for mounting in shoes must be waterproof to avoid short circuit caused by water or moistures permeated thereinto. The flash generator must also be rigid and pressure-resistant to avoid a crashed circuit thereof. For these purposes, the flash generator usually includes a rigid case. When wearing shoes having such flash generators mounted therein, a wearer's heels would contact with the rigid cases of the flash generators and feel uncomfortable. When the wearer walks quickly or runs, an impact of the flash generators on the wearer's heels increases that might cause injured heels or ankles. Since the children's shoe are small, there is not extra space in the heels for an additional air cushion to protect the children's heels. Thus, the children's shoes having conventional rigid flash generator mounted therein are potentially dangerous to children's feet.

### SUMMARY OF THE INVENTION

It is therefore a primary object of the present invention to provide a cushioned sound and flash generator mainly for mounting in a heel of a child's shoe, so that a wearer's heel is elastically supported at the heel of the shoe without becoming injured due to the existence of the sound and flash generator below the heel.

To achieve the above and other objects, the cushioned sound and flash generator of the present invention mainly includes a case having a sound and flash generating unit fixedly mounted therein, a cover closed onto the case, and one or more elastic members positioned in the case above the sound and flash generating unit to normally support the cover at a highest possible position relative to the case. The case is provided on walls with a plurality of catches, and the cover is correspondingly provided with a plurality of vertically extended long slots for the catches to movably engage therewith. When a pressure is applied on the sound and flash generator, the elastic members are elastically compressed and the cover is guided by the long slots to elastically move downward relative to the case to provide a good buffer effect.

In the cushioned sound and flash generator of the present invention, the elastic members may be pads made of a material having a high elasticity, such as polyurethane or rubber, or pressure-resistant springs.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a cushioned sound and flash generator according to a preferred embodiment of the present invention;

FIG. 2 is an assembled perspective view of FIG. 1;

FIG. 3 is a partially sectioned side view of the cushioned sound and flash generator of FIG. 2 in a non-compressed state;

FIG. 4 is a partially sectioned side view of the cushioned sound and flash generator of FIG. 2 in a compressed state;

FIG. 5 is an exploded perspective view of a cushioned sound and flash generator according to another embodiment of the present invention; and

FIG. 6 is a partially sectioned side view of the cushioned sound and flash generator of FIG. 5 in a non-compressed state.

### DETAILED DESCRIPTION OF THE PREFERRED EMBODIMENTS

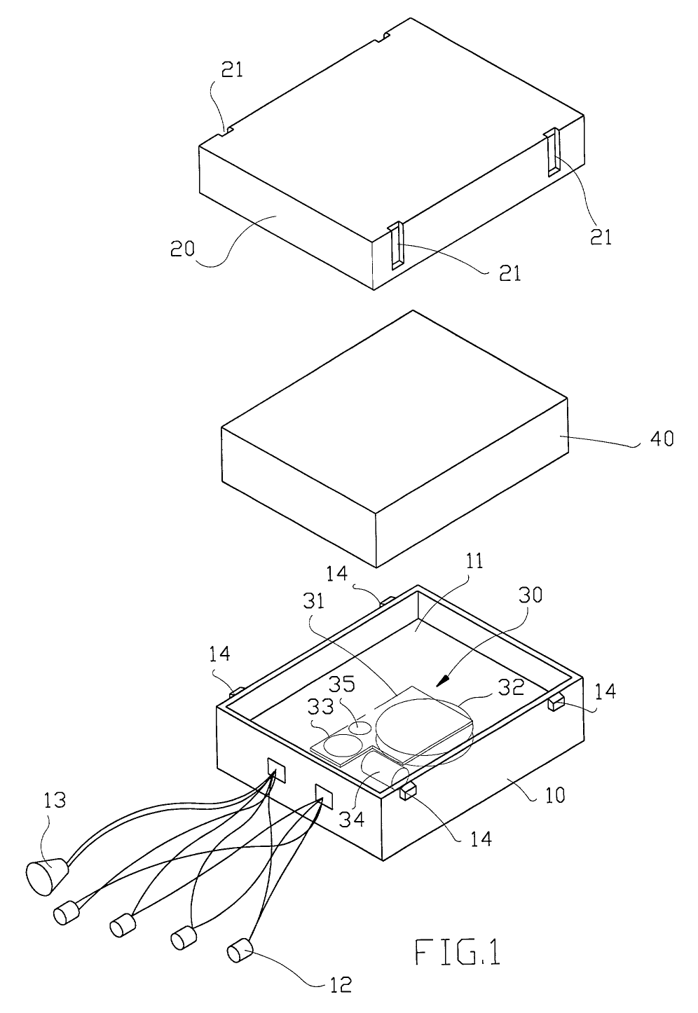

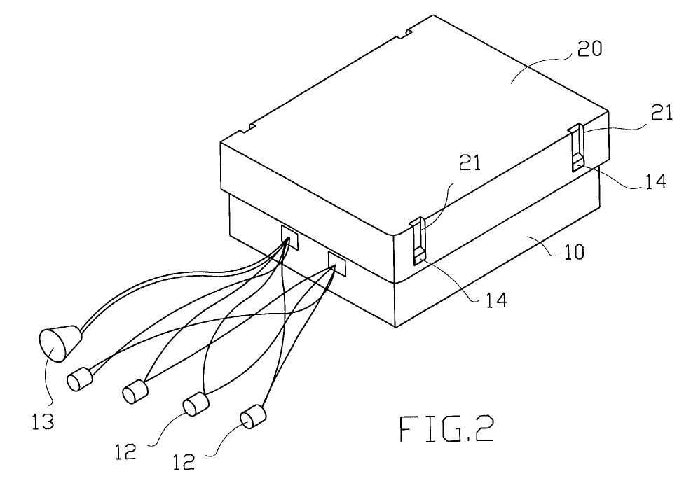

Please refer to FIGS. 1 and 2 that are exploded and assembled perspective views, respectively, of a cushioned sound and flash generator according to a preferred embodiment of the present invention. As shown, the cushioned sound and flash generator mainly includes an open-topped case 10, a cover 20 closing the open top of the case 10, a rigid and watertight sound and flash generating unit 30 mounted in the case 10, and one or more elastic members 40 received in the case 10 above the sound and flash generating unit 30.

The case 10 is provided at each top edge of two opposite walls with two catches 14, and the cover 20 is provided on two opposite walls at positions corresponding to the catches 14 with four vertically extended long slots 21. Alternatively, the four long slots 21 may be replaced with four pairs of vertically extended slide rails 21. When the cover 20 is closed onto the open top of the case 10 with the long slots 21 engaged with the catches 14, the cover 20 is vertically slidable relative to the case 10 within a range defined by a height of the long slots 21.

The sound and flash generating unit 30 mainly includes a base 31, a battery 32, a sound/flash control IC 33, a vibration-actuated switch 34, a light-actuated sensor 35, a plurality of light-emitting elements 12, and a waterproof film-type loudspeaker 13. All the components of the sound and flash generating unit 30, except the light-emitting elements 12 and the film-type loudspeaker 13, are fixedly mounted in the case 10 and completely enclosed in a rigid and watertight outer layer by injecting a type of transparent resin 11 into the case 10. The light-emitting elements 12 and the loudspeaker 13 are located outside the case 10 and connected to the resin-enclosed part of the sound and flash generating unit 30 via extended conductors. When the case 10 and the cover 20 are made of a transparent material, the light-emitting elements 12 may also be directly provided on the base 31 and enclosed in the transparent resin 11. The film-type loudspeaker 13 is preferably located at a position adjacent to an external space to ensure good transmission of sound produced by the sound and flash generating unit 30. The sound and flash control IC 33 may be alternatively replaced with a flash control IC. In this case, the loudspeaker 13 may be omitted.

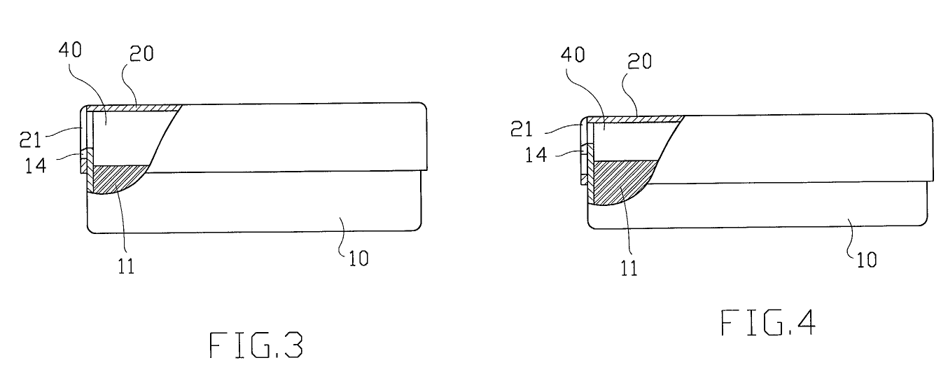

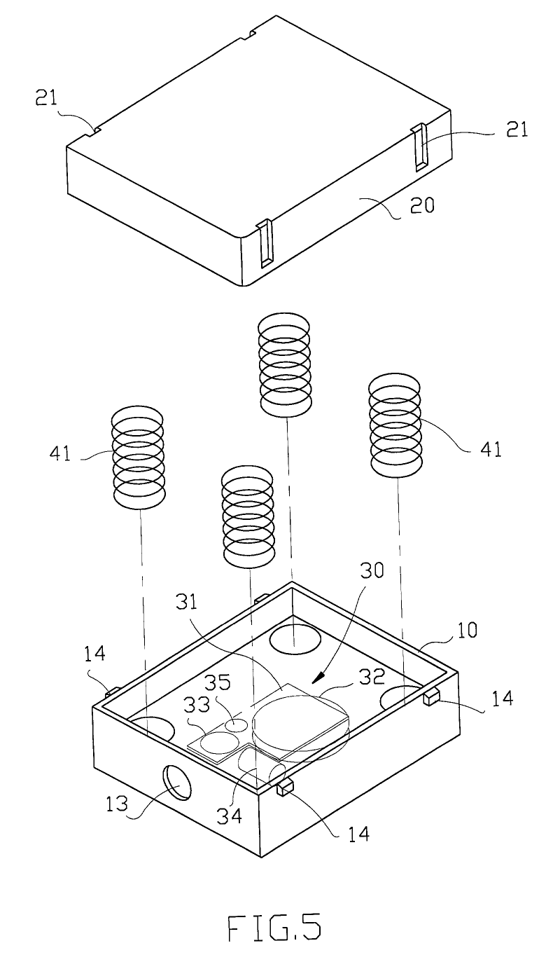

The elastic members 40 may be pads made of a material having a high elasticity, such as polyurethane (PU) or rubber. The elastic members in the form of pads 40 are positioned in the case above the sound and flash generating unit 30 and below the cover 20. Please refer to FIG. 3. When the cushioned sound and flash generator of the present invention is not subjected to any downward pressure and the elastic members 40 are in a non-compressed state, the cover 20 is supported by the elastic members 40 to locate at a highest possible position relative to the case 10 with the catches 14 of the case 10 abutted against a lower end of the long slots 21 of the cover 20. On the other hand, when the cushioned sound and flash generator of the present invention is subjected to a downward pressure, that is, a downward force applied by a wearer's heel on the cushioned sound and flash generator, the elastic members 40 are elastically compressed and the cover 20 elastically descends relative to the case 10 while the catches 14 of the case 10 move upward along the long slots 21, as shown in FIG. 4. In other words, the elastic members 40 provide good buffering effect during the process of compression and therefore protect the wearer's heel and ankle from becoming injured when the wearer's heel is in contact with the sound and flash generator.

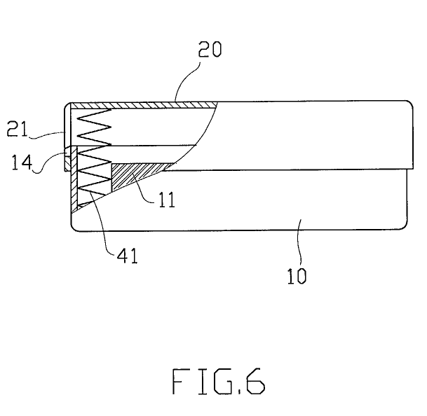

Please refer to FIG. 5 that is an exploded perspective view of a cushioned sound and flash generator according to another embodiment of the present invention. In this embodiment, the elastic members 40 include four springs 41 separately fixed at four corners of the case 10. When the cushioned sound and flash generator of the present invention is not subjected to any downward pressure and the springs 41 are in a non-compressed state, the cover 20 is supported by the springs 41 to locate at the highest possible position relative to the case 10. On the other hand, when the cushioned sound and flash generator of the present invention is subjected to a downward pressure applied on the cover 20, the springs 41 are compressed and the cover 20 elastically moves downward to provide a good buffer effect.

The cushioned sound and flash generator of the present invention is mainly used in a heel of a shoe. When the light-emitting elements 12 included in the present invention emit lights through the function of the sound and flash generating unit 30, they make a wearer clearly visible by a driver of a car coming from a rear side of the wearer, and are therefore useful in protecting the wearer walking in the night or in a dark place. Moreover, the elastic members 40 included in the present invention enable the shoes having the present invention mounted therein to function like a pair of cushioned shoes that are more comfortable and safer for wearing. The cushioned sound and flash generator of the present invention may also be used with other things, such as a carpet, to create funs in our life.

In brief, when the cushioned sound and flash generators of the present invention are mounted in the heels of children's shoes, their elastic compressibility provides a good buffer effect to protect the wearer's heels that are in heavy contact with the heels of shoes, particularly when the wearer is walking or running.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A cushioned sound and flash generator, comprising a rigid open-topped case, a rigid cover closing an open top of said case, a sound and flash generating unit fixedly mounted in said case and completely enclosed in a rigid and watertight outer layer formed by injecting a transparent resin into said case, and one or more elastic members positioned in said case above said sound and flash generating unit and below said cover; said cushioned sound and flash generator being characterized in that said case is provided at each top edge of two opposite walls with two catches, and said cover is provided at positions corresponding to said catches with four vertically extended long slots to movably engage with said catches when said cover is closed onto said case, and that said cover closed onto said case is normally supported by said elastic members to locate at a highest possible position relative to said case; whereby when said cushioned sound and flash generator is subjected to a downward pressure applied on said cover, said elastic members below said cover are elastically compressible to provide a good buffer effect.

2. The cushioned sound and flash generator as claimed in claim 1, wherein said elastic members are pads made of a material having a high elasticity.

3. The cushioned sound and flash generator as claimed in claim 2, wherein said material having a high elasticity is polyurethane.

4. The cushioned sound and flash generator as claimed in claim 2, wherein said material having a high elasticity is rubber.

5. The cushioned sound and flash generator as claimed in claim 1, wherein said elastic members are pressure-resistant springs.
